(19) United States
(12) Patent Application Publication
(10) Pub. No.: US 2004/0047636 A1
(43) Pub. Date: Mar. 11, 2004

(54) Chromatic dispersion compensation

(76) Inventors: Kenneth Guild, Essex (GB); Michael O'Mahony, Suffolk (GB); Dimitra Simeonidou, Essex (GB); Anna Tzanakaki, Essex (GB)

Correspondence Address: NIXON & VANDERHYE, PC, 1100 N GLEBE ROAD, 8TH FLOOR, ARLINGTON, VA, 22201-4714, US

(21) Appl. No.: 10/275,920

(22) PCT Filed: May 9, 2001
(86) PCT No.: PCT/GB01/02027

(30) Foreign Application Priority Data
May 10, 2000 (GB) 0011143.5

(51) Int. Cl. H04B 10/12

(52) U.S. Cl. 398/147

(57) ABSTRACT

In the present invention, fast dynamic dispersion compensation on a per-packet basis is performed by using a header recognition scheme at each node in an optical network to extract from each packet the path and bit-rate information. A decision can then be taken on whether dispersion compensation is needed for that packet, and if so, what would be a suitable amount of such compensation.

### FIELD OF THE INVENTION

This invention relates to a method of applying chromatic dispersion compensation to data transmitted over an optical transmission network, as well as to apparatus for performing such dispersion compensation.

### BACKGROUND TO THE INVENTION

The growth of traffic over optical data transmission networks has risen very rapidly in recent years, and in particular the growth of Internet traffic has been especially remarkable. Network providers are having difficulties keeping up with the ever-increasing demand and various techniques are being deployed to ensure the networks will have sufficient capacity for the envisaged growth. In particular, all-optical packet switching techniques are being adopted in order to have a low-latency optical core network, so minimising delays at switching nodes.

Network operators are also deploying dense wavelength division multiplexing (DWDM) equipment, further to increase the capacity of their already existing optical fibre infrastructures. Such DWDM equipment is especially suitable for handling the ever-increasing demand for Internet traffic, which normally is in the form of Internet protocol (IP) packets.

The payload of an optical packet stream may range from a few megabits/second to several gigabits/second of user data, but such a packet stream must be able to traverse an optical packet network without incurring any significant loss of data. However, the possibility of a packet in transit over the infrastructure suffering chromatic dispersion increases with the optical fibre link length and consequently severe limitations will be imposed on the length of such links, and so the distance over which a packet may travel, before dispersion compensation is required. The distance limitation will depend upon the routing path and wavelength for a packet and generally becomes more important as the bit-rate of the payload increases.

In order to overcome the chromatic dispersion problem, the current procedure is to apply compensation to a received packet after transmission of that packet over an optical fibre link. However, system performance can be significantly improved by applying compensation less frequently (that is, after transmission over more than one such link), particularly in the case of dense wavelength division multiplexed signals.

In a simple point-to-point optical fibre link, dispersion compensation can be performed using dispersion compensation gratings, which can be arranged effectively to remove linear dispersion from received signals. Moreover, in a wavelength division multiplexed network, such dispersion compensating gratings can be used to remove dispersion in a dynamic fashion, for each transmitted wavelength. Unfortunately, in the case of a packet-switched network, the problem is significantly more complex because packets travelling over various network paths may be expected to arrive at the same network node but having accumulated very different amounts of chromatic dispersion. At best, the application of a fixed amount of dispersion compensation is no more than a compromise for an “average” packet, and so may be expected still to impose a penalty on a packet. A further complication is that the same amount of cumulative dispersion will impose different penalties on packets having different bit rates.

The present invention aims at addressing the above problems, to permit dynamic chromatic dispersion compensation to data packets transmitted over an all-optical network, to improve system performance and minimise the dispersion penalties.

### SUMMARY OF THE INVENTION

According to a first aspect of the present invention, there is provided a method of applying dispersion compensation to a data packet transmitted over an optical network, comprising extracting from a packet arriving at a switching node information concerning at least one of the path followed by the packet and the bit-rate of the packet, deciding whether compensation is required on the basis of the extracted information, and then directing the packet to a dispersion compensating unit able to apply an appropriate amount of dispersion compensation to the packet.

According to a second aspect of the present invention, there is provided an apparatus to effect dispersion compensation on a data packet transmitted over an optical network, which apparatus comprises means to extract from a packet arriving at a switching node information concerning at least one of the path followed by the packet and the bit-rate of the packet, control means to calculate what compensation (if any) is required for the packet on the basis of the extracted information, a dispersion compensating unit able to apply an appropriate amount of dispersion compensation to a received packet, and switch means operated in response to the output of th control means and able to direct the packet to said dispersion compensating unit.

In the present invention, it is proposed that fast dynamic dispersion compensation on a per-packet basis is performed. This is achieved by using a header recognition scheme at each node to extract from each packet the path and bit-rate information. Then, from that information, a decision can be taken on whether dispersion compensation is needed for that packet, and if so, what would be a suitable amount of such compensation. It is anticipated that not all incoming packets will require dispersion compensation and so may be passed through the switching node. This will increase the distance over which the packet may be transmitted before requiring compensation, and in turn, this may be expected to enhance the system performance, particularly in the case of a wavelength multiplexed network.

The compensation to be applied by the dispersion compensating unit may be adjustable, in which case an appropriate signal should be sent to the unit following the is calculation of the required amount of dispersion, derived from the information extracted from the packet, whereby the dispersion compensating unit will apply the required amount of compensation to that packet. Alternatively, a plurality of dispersion compensation units may be provided, each arranged to apply different amounts of compensation. Then, the amount of dispersion required for any given packet may be calculated from the extracted information from the packet, whereafter the packet is directed to an appropriate dispersion compensating unit which is able to apply the required amount of compensation, as derived from the calculation. In the latter case, there should also be a “straight through” path for a packet, whereby appropriate direction of that packet results in no compensation being applied, should it be determined that no dispersion compensation is required.

It is important that the dispersion compensating unit should not introduce any penalty, or only an insignificant penalty, as compared to the penalty which would be imposed by virtue of the chromatic dispersion, when no dispersion compensation is employed. To this end, the compensation may be performed using dispersion compensating gratings, appropriately configured to remove a preset amount of chromatic dispersion.

### BRIEF DESCRIPTION OF THE DRAWINGS

An example of the present invention will now be described in detail with reference to the accompanying drawings, in which:

FIG. 1 diagrammatically illustrates the principle of the dispersion compensation method of this invention; and,

FIG. 2 illustrates a dynamic dispersion compensation scheme for a variable bit-rate wavelength division multiplexed packet-switched network.

### DETAILED DESCRIPTION

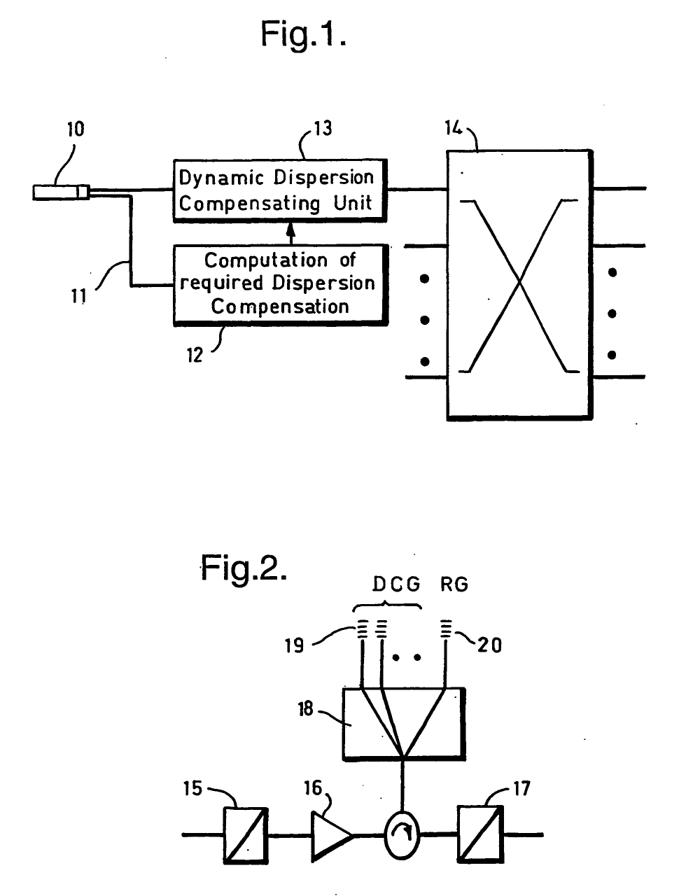

FIG. 1 diagrammatically illustrates an optical fibre 10 along which is transmitted an optical packet stream. A portion of the optical signal is coupled into a branch 11 and fed to a real-time computation unit 12, which extracts the header information from the packet and uses the extracted information to compute the required amount of dispersion compensation. The header contains information concerning the path followed by the packet in reaching the node and the bit-rate of the packet and this information is used for the dispersion compensation computation. As a result of that calculation, an appropriate signal is supplied to a dynamic dispersion compensating unit 13, which may be adjusted dynamically to apply the computed degree of dispersion compensation. The principal part of the optical signal is supplied directly to the dynamic dispersion compensating unit 13, whereat it is subjected to the required degree of chromatic dispersion compensation, having regard to the transmission history of that packet.

The output from the dispersion compensating unit 13 is supplied to a known form of photonic switch 14, within which the packet is routed as required, having regard to its intended destination.

Referring now to FIG. 2, there is shown diagrammatically a dynamic dispersion compensation scheme for a variable bit-rate wavelength division multiplexed packet-switched network. The incoming signal is supplied to a first tuneable wavelength converter 15, and is amplified at 16 before being passed on to a second tuneable wavelength converter 17. The wavelength conversion technique used in this configuration should maintain the spectral characteristics of the input signal. An arrayed waveguide grating is coupled to a plurality of dispersion compensating gratings 19 as well as a reflection grating 20, which latter effects no dispersion compensation. By extracting the header information and computing the required degree of dispersion compensation as described above with reference to FIG. 1, th arrayed waveguide grating 18 may be controlled to have ach packet subjected to dispersion compensation by the appropriate grating 19, or if no compensation is required, by the grating 20. In this way, a fully dynamic compensation regime may be achieved, for a variable bit-rate wavelength division multiplexed optical signal having variable bit-rate packets transmitted thereover.

1. A method of applying dispersion compensation to a data packet transmitted over an optical network, comprising extracting from a packet arriving at a 5 switching node information concerning at least one of the path followed by the packet and the bit-rate of the packet, deciding whether compensation is required on the basis of the extracted information, and then directing the packet to a dispersion compensating unit able to apply an appropriate amount of dispersion compensation to the packet.

2. A method according to claim 1, wherein the decision on the appropriate amount of dispersion compensation to be applied to the packet is taken on the basis of both the path followed by the packet and the bit-rate of the packet.

3. A method according to claim 1 or 2, wherein the compensation applied by the dispersion compensating unit is adjustable.

4. A method according to claim 3, wherein the amount of dispersion required is calculated from the extracted information, and then the dispersion compensating unit to which the packet is directed is driven with, an appropriate signal to adjust that unit to apply the required compensation as derived from the calculation.

5. A method according to claim 1 or 2, wherein a plurality of dispersion compensating units are provided and arranged to apply different amounts of compensation, the amount of dispersion required for any given packet is calculated from the extracted information, and then the packet is directed to an appropriate dispersion compensating unit able to apply the required compensation as derived from the calculation.

6. A method according to any preceding claim, wherein a dispersion compensation grating is employed to apply dispersion compensation to a packet directed thereto.

7. A method according to any preceding claim, wherein the packet forms a part of a packet str am transmitted over the optical network as a wavelength division multiplexed optical signal.

8. A method according to any preceding claim, wherein the dispersion-compensated optical signals are supplied to a photonic switch to permit the required switching functions to be performed on the compensated optical signals.

9. An apparatus to effect dispersion compensation on a data packet transmitted over an optical network, which apparatus comprises means to extract from a packet arriving at a switching node information concerning at least one of the path followed by the packet and the bit-rate of the packet, control means to calculate what compensation (if any) is required for the packet on the basis of the extracted information, a dispersion compensating unit able to apply an appropriate amount of dispersion compensation to a received packet, and switch means operated in response to the output of the control means and abl to direct the packet to said dispersion compensating unit.

10. An apparatus according to claim 9, wherein there is a plurality of dispersion compensating units each arranged to apply different amounts of dispersion compensation, and the switch means directs a received packet to a selected dispersion compensating unit able to apply an appropriate amount of dispersion compensation.
